(19) United States
(12) Patent Application Publication
(10) Pub. No.: US 2026/0049569 A1
(43) Pub. Date: Feb. 19, 2026

(54) SUPERCHARGED AIR DUCT FOR PROVIDING SUPERCHARGED AIR TO AN INTERNAL COMBUSTION ENGINE

(71) Applicant: Dr. Ing. h.c. F. Porsche Aktiengesellschaft, Stuttgart (DE)

(72) Inventor: Werner Verdoorn, Ludwigsburg (DE)

(73) Assignee: Dr. Ing. h.c. F. Porsche Aktiengesellschaft, Stuttgart (DE)

(21) Appl. No.: 19/302,294

(22) Filed: Aug. 18, 2025

(30) Foreign Application Priority Data
Aug. 19, 2024 (DE) 102024123552.7

(51) Int. Cl. F02B 29/04; F01N 13/08; F02M 35/10

(52) U.S. Cl. CPC F02B 29/0412; F01N 13/08; F02M 35/10157; F02M 35/10255

(57) ABSTRACT

A supercharged air duct for providing supercharged air to an internal combustion engine. The air duct includes at least the following components in the stated order along the flow direction: a compressor turbine of a turbocharger; an intercooler for cooling compressed supercharged air of the compressor turbine; a Ranque-Hilsch cyclone tube having an inflow outlet and having a return flow outlet; and a return throttle for the return flow of the Ranque-Hilsch cyclone tube. During operation, an inflow further cooled from the cooled supercharged air flows out via the inflow outlet for a combustion chamber of the internal combustion engine and a heated return flow flows out via the return flow outlet.

### CROSS-REFERENCE TO RELATED APPLICATION

This application claims priority to German Patent Application No. 10 2024 123 552.7, filed Aug. 19, 2024, the content of such application being incorporated by reference herein in its entirety.

### FIELD OF THE INVENTION

The invention relates to a supercharged air duct for providing supercharged air to an internal combustion engine, a method having such a supercharged air duct for cooling supercharged air for an internal combustion engine, an internal combustion engine having such a supercharged air duct for a motor vehicle, and a motor vehicle having such an internal combustion engine.

### BACKGROUND OF THE INVENTION

In internal combustion engines charged by a turbocharger, the competing goals of high specific performance and as low a combustion temperature as possible in the combustion chamber is a challenge. One solution is to inject water into the combustion chamber in order to lower the combustion temperature. However, in a mobile application, for example a motor vehicle, water in a tank must be carried along and refilled regularly.

### SUMMARY OF THE INVENTION

The invention relates to a supercharged air duct for providing supercharged air to an internal combustion engine, comprising at least the following components in the stated order along the flow direction:
a compressor turbine of a turbocharger;
an intercooler for cooling compressed supercharged air of the compressor turbine;
a Ranque-Hilsch cyclone tube having an inflow outlet and having a return flow outlet, wherein, during operation, an inflow further cooled from the cooled supercharged air flows out via the inflow outlet for a combustion chamber of an internal combustion engine and a heated return flow flows out via the return flow outlet; and
a return throttle for the return flow of the Ranque-Hilsch cyclone tube.

Unless explicitly stated otherwise, ordinal numbers are used in the preceding and the following description only for the purposes of clear distinction and do not reflect any order or ranking of the designated components. An ordinal number greater than one does not imply that another such component has to necessarily be present.

The supercharged air duct is positioned upstream of the intake chamber of an internal combustion engine along the flow direction of the (oxygen-rich) air to the combustion chamber of the internal combustion engine.

A turbocharger is driven (usually exclusively) by exhaust gas of the internal combustion engine conducted via an exhaust channel, thereby using the otherwise unused emitted kinetic energy of the exhaust for recharging the combustion chamber, i.e., raising the intake pressure to a pressure above atmospheric pressure of, for example, 1.5 bar [one and a half bar] to 2.5 bar. The mechanical and thermal stress on the internal combustion engine increases with pressure, which can reduce the life of the engine. Higher pressures, such as above about 3 bar, can result in an overloading of the internal combustion engine, which can result in engine damage such as cylinder head gasket damage or piston cracks.

By means of the turbocharger or its compressor turbine, air is drawn in (usually from the environment) and compressed to a desired charge pressure. The air is heated, namely to an impermissibly high temperature, for example at a desired charge pressure of about 2.5 bar at a normal ambient temperature of, for example, about 20° C. to about 180° C. [one hundred eighty degrees Celsius]. Thus, the supercharged air must be cooled, for example to 15° C. [fifteen degrees Celsius].

In full-load operation of an internal combustion engine, in many cases, excessive compression output is provided from the exhaust gas due to the range of operation of the turbocharger to be applied. Previous solutions provide for bypassing the exhaust turbine of the turbocharger and/or converting a portion of the torque generated in the turbocharger into usable electrical energy by means of recuperation.

A different approach is selected here, in which the excess output in full-load operation, in which the excessively high temperatures of the supercharged air occur, is used directly to cool the supercharged air. In the first approach, the supercharged air is compressed to too high a pressure and too high a temperature. In the second step, this excess energy of the supercharged air is relieved and cooled by means of a Ranque-Hilsch cyclone tube. This will be explained in further detail below.

It should be noted that a Ranque-Hilsch cyclone tube does not comprise any moving parts and is therefore very robust, safe, and has a low risk of requiring maintenance. According to the present proposal, the remaining system of the supercharged air duct is also simply constructed and has a low overall mass.

In a Ranque-Hilsch cyclone tube, a pressurized gas is divided into two sub-flows that perform an (open) counter-flow cooling to each other such that a heated sub-flow and a cooled sub-flow are generated from the (only) compressed air supply. The pressurized gas (here, the supercharged air from the compressor turbine) is blown into a cyclone chamber of the Ranque-Hilsch cyclone tube tangentially to an axis of rotation, wherein the supercharged air is set into a very fast rotation about the axis of rotation with rotation numbers of up to 1,000,000 rpm [one million revolutions per minute]. The cyclone chamber is equipped with differently designed axial air outlets (defined in relation to the axis of rotation), here first an inflow outlet for the cold supercharged air for a combustion chamber of an internal combustion engine and second a return flow outlet for the exhaust air heated during the process. In technical applications, it is generally possible to achieve temperature differences of +20° C. to −50° C. with a compressed air supply of 6 bar, wherein the greater part of the air flow is then heated. During the operation of the apparatus, a characteristic whistling sound is produced with a frequency of about 3 kHz and a loudness of about 120 dB. Very high centripetal forces occur in the cyclone chamber which however cannot accomplish the observed separation alone into an outer warm flow and inner cold flow. It is ensured that the very loud whistling sound is necessary by means of processes not yet fully understood, because once this is dampened by coupled absorbent resonators, the temperature difference decreases to only a few Kelvins. In addition, a Ranque-Hilsch cyclone tube has very low efficiency compared to conventional cooling methods.

In the following, it is explained in detail how this Ranque-Hilsch cyclone tube is efficiently used in the proposed supercharged air duct.

The compressor turbine of a turbocharger, which is driven (for example exclusively) by means of an exhaust turbine of the turbocharger from the exhaust of the associated internal combustion engine, draws in air (usually from the immediate environment) via an air inlet (preferably directed via an air filter). It should be noted that in certain operating conditions, a closed circle can be formed in which no air is required from the outside or can be sucked in. It should further be noted that in one embodiment, the compressor turbine is driven solely or additionally by means of an electric prime mover.

For optimum operation, it is proposed here that the air converted into supercharged air is brought to a pressure above a desired charge pressure in the intake chamber by means of the compressor turbine, for example to 4 bar [four bar]. The supercharged air is also heated more strongly than conventionally, in the example mentioned to 250° C. [two hundred and fifty degrees Celsius].

Subsequently, in the flow direction of the supercharged air, however, the compressor turbine is not directly connected to the Ranque-Hilsch cyclone tube, but rather to an intercooler, as is common in an embodiment without the Ranque-Hilsch cyclone tube. However, by means of the intercooler (in a desired cyclone cooling operation by means of the Ranque-Hilsch cyclone tube), the supercharged air is not cooled to the desired temperature of the supercharged air in the intake chamber but rather brought to a significantly increased temperature level. In the aforementioned example, behind the intercooler, the pressure lies at 4 bar (cooling takes place approximately isobarically) and the temperature lies at 50° C. [fifty degrees Celsius].

This supercharged air that is still too warm is now introduced via the compressed air inlet of the Ranque-Hilsch cyclone tube (tangential to its axis of rotation) for cooling and relieving. Here, for example, it is optimal to achieve a temperature of 15° C. and a charge pressure of 2.5 bar in the inflow for the intake chamber of the internal combustion engine emitted via the inflow outlet. For an optimal efficiency, the significantly greater partial flow is the one with the heated air, for example in a ratio of 3:1 [three to one] to the cooled partial flow, as described above.

On the contrary, however, it is proposed here that the cooled partial flow, i.e., the inflow, is significantly larger than the heated partial flow, i.e., the exhaust air or the return flow, for example for the temperature and charge pressure to be achieved in the aforementioned example, in a ratio of 1:3 [one to three] of the return flow to the inflow, in other words 75% is emitted via the inflow outlet and 25% via the return flow outlet. In this example, a temperature of 120° C. and (necessarily likewise) a pressure of 2.5 bar is produced. This ratio with the result of the temperatures and pressure of the inflow and return flow is achieved and thus controlled (usually regulated) by means of the return throttle behind the return flow outlet.

Thus, in addition to the goal of an optimal temperature and charge pressure, as well as the prevention of the use of water in the combustion chamber, the following is further achieved:
the excess kinetic energy of the exhaust is used in the Ranque-Hilsch cyclone tube for cooling the supercharged air, and no recuperation is necessary on the turbocharger;
the operating point of the Ranque-Hilsch cyclone tube required in this architecture of the supercharged air duct decreases the loudness of the characteristic whistling sound; and
the Ranque-Hilsch cyclone tube is preferably used actively (and generates the loud whistling sound) only when the internal combustion engine is operated under a high load, for example a full load, wherein a total high volume is at least accepted, and sometimes even desired.

It is further proposed in an advantageous embodiment of the supercharged air duct that a return channel having a heat exchanger is further provided between the return flow outlet of the Ranque-Hilsch cyclone tube and the compressor turbine for recirculating the return flow.

Here, it is further proposed that the return flow be provided again via a return channel of the compressor turbine in addition to the air (for example, from the immediate environment). The return flow contains contaminants due to blowby gases and lubricating oil leakage, among other things, so that the return flow should not be emitted back to the environment untreated, and this does not meet the requirements in most countries. Instead of simply feeding the return flow into the exhaust flow via a catalyst, a repeated feeding to the compressor turbine is proposed here.

As described above, this partial flow is heated, for example to 120° C. Here, it is proposed that a heat exchanger is provided in the return channel. By means of the heat exchanger, for example, the return flow is increased to about 20° C., optionally more or less, in order to bring the drawn (mixing) air to a suitable temperature, for example 20° C., in the mixture of ambient drawn air before the compressor turbine. Preferably, cooling off is also performed (approximately) isobarically in the heat exchanger. Preferably, the return throttle is positioned downstream of the heat exchanger in the flow direction. Preferably, a reduction in the pressure in the return flow to the atmospheric pressure is carried out by means of the return throttle, alternatively from a separate relief nozzle.

The heat exchanger has yet another advantage, namely that the (air) sonic emission caused by the process in the Ranque-Hilsch cyclone tube is further reduced, as well as that (as mentioned above) the temperature of air drawn in by the compressor turbine can be regulated to a desired (for example constant) temperature.

In one embodiment, the recirculation channel is openly connected to an intake channel for the air drawn from the environment of the compressor turbine such that the mixing ratio between return flow and (fresh) air is passively adjusted.

It is further proposed, in an advantageous embodiment of the supercharged air duct, that a bypass channel is further provided with a bypass throttle valve, wherein supercharged air can be conducted by means of the bypass channel behind the intercooler past the Ranque-Hilsch cyclone tube into an intake chamber of an internal combustion engine.

It should be noted that a supercharged air duct is explained here only with regard to the application described herein, and it is not ruled out that further lines, sections, and devices are provided permanently or in a switchable manner, which, for example, also permit another mode of operation of the supercharged air duct.

As already described, an optimal operating point is the full-load operation of the internal combustion engine associated with the supercharged air path (i.e., the one to be recharged). Outside of this, sufficiently low pressures and temperatures occur in the supercharged air, and/or deviating values can be conventionally discharged (via an intercooler).

Here, it is proposed that, for operation outside of critical operating points in the intake chamber of the internal combustion engine and/or in the exhaust driven turbocharger, supercharged air is directed past the Ranque-Hilsch cyclone tube through a bypass channel from the intercooler to the intake chamber of the associated internal combustion engine. A bypass throttle valve is provided in order to connect the bypass channel, which fully opens the entire volume flow of the supercharged air into the intake chamber via the bypass channel, for example solely due to the higher back-pressure caused by the Ranque-Hilsch cyclone tube or (possibly additionally) by means of a throttle valve (before and/or preferably exclusively behind) the Ranque-Hilsch cyclone tube.

According to a further aspect, a method for cooling supercharged air for an internal combustion engine by way of a supercharged air duct according to an embodiment according to the above description is proposed, wherein the method comprises at least the following steps in the stated order:
a. by means of the compressor turbine, compressing the supercharged air to over 3 bar;
b. by means of the intercooler, pre-cooling the compressed supercharged air to between 80° C. and 30° C.;
c. by means of the Ranque-Hilsch cyclone tube, cooling off the pre-cooled supercharged air to a target temperature of below 20° C. and relieving to a target charge pressure of 3 bar or less,
   wherein the cooling off of the supercharged air to a desired target temperature is controlled by means of adjusting the return flow from the Ranque-Hilsch cyclone tube of the return throttle,
   wherein the flow volume of the return flow is less than the inflow.

The method proposed herein is a preferred operating method for the supercharged air duct in an embodiment according to the present description. It should be noted that the supercharged air duct can be operated differently and the method can be applied to another (similar) supercharged air duct. To the extent to which aspects of the method are already described in the description with respect to the supercharged air duct, these are at least optionally the subject matter of the method proposed herein.

In step a., the supercharged air is compressed by means of a compressor turbine of the turbocharger. The supercharged air is brought to a charge pressure of over 3 bar. An optimal charge pressure is 4 bar, because it makes the Ranque-Hilsch cyclone tube optimal for a desired charge pressure (for example 2.5 bar) and charge temperature (for example 15° C.). For example, the air drawn in by the compressor turbine is heated to 250° C.

In step b., the supercharged air is pre-cooled by means of the intercooler. The supercharged air is brought to a temperature of between 80° C. and 30° C. The supercharged air cooling is preferably done approximately isobarically. An optimal temperature is 50° C., because at this temperature the supercharged air is brought to a temperature level after the intercooler, which leads to an advantageous ratio of (low) return flow and (high) inflow in the Ranque-Hilsch cyclone tube.

In step c. of the method, the pre-cooled supercharged air is further cooled by means of the Ranque-Hilsch cyclone tube. The supercharged air is cooled off to a target temperature of below 20° C. and is relieved to a target charge pressure of 3 bar or less. The Ranque-Hilsch cyclone tube is fed (preferably controlled) via the compressed air inlet in such a way that the desired target temperature and the desired charge pressure are achieved. In one embodiment, the input pressure and/or input temperature of the supercharged air at the compressed air inlet of the Ranque-Hilsch cyclone tube varies. Alternatively or additionally, the desired target temperature and/or charge pressure fluctuates within a specified operating window.

An optimal temperature in step c. is 15° C. and an optimal charge pressure is 2.5 bar, because at this charge pressure and charge temperature, conditions are optimal for the combustion process in the combustion chamber or for a long service life of an internal combustion engine. The Ranque-Hilsch cyclone tube is designed in a geometrically optimized manner for these (or other) desired values and/or supplied with compressed air at the compressed air inlet.

By means of the return throttle, the flow resistance can be adjusted (i.e., controlled or regulated) at the return flow outlet of the Ranque-Hilsch cyclone tube, wherein the charge pressure is preferably solely dependent on the pressure supplied by the compressor turbine, and the temperature can be changed (quasi-isobarically) by means of the return throttle by changing the ratio of flow volumes from the return flow to the inflow.

It should be noted that, contrary to the conventional operating mode of a Ranque-Hilsch cyclone tube, the flow volume of the return flow is (preferably significantly) lower than that of the inflow. This also permits the recycling of the return flow to the compressor turbine without the need to remove an excess from the heated exhaust air. In one embodiment, the flow volume of the return flow is always less than twice that of the inflow, so that in such an operating point, no air is drawn in from the environment and no excess of exhaust air is present. Alternatively, at an operating point, an excess of exhaust is fed into the exhaust and preferably conducted via a catalyst.

It is further proposed in an advantageous embodiment of the method that, by means of a supercharged air duct according to an embodiment according to the above description, the return flow is fed again via the return channel from the return flow outlet of the Ranque-Hilsch cyclone tube prior to the compressor turbine, wherein the return flow is cooled down to below 55° C., preferably below 35° C. or less, by means of the heat exchanger.

By feeding the return flow from the Ranque-Hilsch cyclone tube directly to the compression, on the one hand, the (possibly contaminated) exhaust air of the cooling process in the Ranque-Hilsch cyclone tube is trapped again and thus not discharged unused to the environment and, on the other hand, the compressor turbine with adjustable or at least dampable fluctuations of the supply air from the environment. In this circuit, any contamination if present is assumed to originate almost exclusively from the compressor turbine (especially from blowby gases, lubricants) and thus does not impair operation.

In an optimal mode of operation, the return flow is cooled to 20° C., for example an optimal ambient temperature. However, in some operating conditions, the air of the environment is warmer or colder. By means of the heat exchanger in the return channel, nearly any temperature can be set, so that the actual present ambient temperature can be adjusted to an optimal temperature together with the temperature of the cooled return flow, for example to the often optimal 20° C. In one embodiment, by means of structural measures that influence a flow and/or by means of a pressure in the return flow slightly above 1 bar (i.e., ambient pressure), it is ensured that the return flow is safely drawn back into the compressor turbine and fed to the method, whereas only as much fresh air is sucked in from the ambient air as is additionally required, i.e., for 25% of the return flow portion, 75% of fresh air from the environment.

It is further proposed, in an advantageous embodiment of the method, that the flow volume of the inflow to the internal combustion engine can be controlled by way of an inflow throttle valve.

Different load volumes in the intake chamber are necessary for controlling an internal combustion engine, for example to accelerate or decelerate as desired. This requires an inflow throttle valve, which is located behind the Ranque-Hilsch cyclone tube. In the case of a bypass channel, the inflow throttle valve is preferably also arranged between the bypass channel and the intake chamber. Preferably, the inflow throttle valve is controlled or regulated in communication with the return throttle such that the desired temperatures and pressure can be produced in the Ranque-Hilsch cyclone tube. In one embodiment, the ratio of the inflow to the return flow is then changed, wherein, for example, a suitable supply temperature is set by means of the intercooler so that no undercooled or overheated air enters into the intake chamber.

It is further suggested, in one advantageous embodiment of the method, that the method is started depending on at least one of the following conditions:
ambient temperature;
temperature of the supercharged air in the intake chamber of the internal combustion engine;
rotational speed of the exhaust turbine;
position of an accelerometer.

In one operating state, the ambient temperature is very high and the heat would otherwise have to be discharged via the intercooler. By starting the method, this thermal energy can be used more sensibly.

In one operating state, the temperature of the supercharged air is too high and the heat would otherwise have to be discharged via the intercooler. By starting the method, the available thermal energy in the Ranque-Hilsch cyclone tube can be used more sensibly.

In one operating state, the speed of the exhaust turbine is very high (with a rigid turbine shaft, also on the compressor turbine). This additional available energy is thus detected via this rotational speed and the method is started, i.e., this energy is used in the thermal energy and then in the Ranque-Hilsch cyclone tube.

In one operating state, the future speed on the exhaust turbine is readable by sensing the position of an accelerometer (e.g., executed as a so-called gas pedal), or by taking this into account. A very early or quick reaction is thus possible in order to make the additionally available energy immediately usable in the Ranque-Hilsch cyclone tube.

It is further proposed in an advantageous embodiment of the method that, for a bypass operation, by way of a supercharged air duct according to an embodiment according to the above description, supercharged air is conducted behind the intercooler past the Ranque-Hilsch cyclone tube into the intake chamber of the internal combustion engine,

wherein, for performing step c. of the method, a positive pressure is preferably generated in the intake chamber prior to or upon a change from bypass operation to cyclone cooling operation by means of the Ranque-Hilsch cyclone tube.

The method is not energy efficient in every operating state, and an adjacent section (the bypass channel) past the Ranque-Hilsch cyclone tube in these other operating states is sensible. Thus, an interference-free supply of supercharged air to an intake chamber is ensured with simple means.

However, as soon as an excess output in relation to a mode of operation of the supercharged air duct without a Ranque-Hilsch cyclone tube is set, a change must take place. Due to the fact that the Ranque-Hilsch cyclone tube has a delayed response, and a short-term positive pressure in the intake chamber is non-critical, a method is proposed herein in which the resulting positive pressure is initially permitted as a result of the excess output of the compressor turbine, and then a switch is made to the Ranque-Hilsch cyclone tube. The resulting pressure drop as a result of the delayed response of the Ranque-Hilsch cyclone tube then immediately de-pressurizes the positive pressure in the intake chamber again, and no tensile force interruption is perceived by the users (for example, vehicle occupants in a driven motor vehicle).

Alternatively or additionally, the bypass channel is relatively slowly depleted and the Ranque-Hilsch cyclone tube is supplied with the desired operating pressure and flow rate correspondingly slowly, wherein the response is shortened.

According to a further aspect, an internal combustion engine for a motor vehicle is proposed, which comprises at least the following components:
at least one combustion chamber;
a supercharged air duct according to one embodiment according to the above description;
an intake chamber for the at least one combustion chamber, which can be charged by way of the supercharged air duct;
an exhaust channel for discharging exhaust from the at least one combustion chamber via the exhaust turbine of the turbocharger,
   wherein an exhaust cleaning device is preferably positioned downstream of the exhaust turbine.

The internal combustion engine is configured for forward drive, directly or indirectly (for example, charging a traction battery). The internal combustion engine is charged by way of a supercharged air duct, wherein the turbocharger is oversized in a maximum operation (the so-called full load) and generates excess output at the compressor turbine. This is converted by means of the Ranque-Hilsch cyclone tube into a suitable, preferably optimal, temperature of the supercharged air in the intake chamber. The turbocharger is powered by the exhaust gas of the at least one (usually plurality of) combustion chambers, namely its exhaust turbine. Preferably, the turbocharger does not have a transmission or recuperation generator, but is simply constructed, preferably with a continuous turbine shaft, such that the exhaust turbine and compressor turbine always have the same speed.

Preferably, an exhaust cleaning device, for example a two-way catalyst, exhaust filter, and/or three-way catalyst, is provided. Preferably, prior to entering the exhaust gas device, only a little pressure and heat is removed from the exhaust gas at the exhaust turbine, so that the exhaust cleaning device is operable in an optimal (high) temperature range and without generating too much back-pressure on the combustion chamber or on the exhaust turbine, respectively, with a significant flow resistance.

According to a further aspect, a motor vehicle is proposed, comprising a transport cabin, a powertrain having an internal combustion engine according to an embodiment according to the above description, and a forward drive axle having at least one forward drive wheel, wherein the at least one forward drive wheel can be driven in order to propel the motor vehicle by means of torque emitted from the powertrain.

The motor vehicle is provided for transporting at least one passenger and/or goods and comprises for this purpose at least one transport cabin (for example, a passenger compartment and/or a cargo compartment). The motor vehicle is driven via at least one forward drive wheel by means of the torque from at least one prime mover (also referred to in this function as a traction machine). At least one of the prime movers is an internal combustion engine and is configured so as to output a torque for propelling the motor vehicle. For example, an electric prime mover is still used, for example, on a second (additional) drive axis of the motor vehicle, while the (fuel-burning) combustion engine is used as the main drive for the motor vehicle. The internal combustion engine is equipped with a supercharged air duct, which achieves a high efficiency and is at the same time simple (also with regard to manufacture and maintenance) and has comparatively low mass (for example, compared to a recuperative system).

### BRIEF DESCRIPTION OF THE DRAWINGS

The above-described invention is discussed in detail in the following in the context of the relevant technical background with reference to the accompanying drawings which show preferred embodiments. The invention is not limited in any way by the purely schematic drawings, wherein it should be noted that the drawings are not true to scale and are not suitable for defining dimensional relationships. The figures show:

FIG. 1: in a schematic illustration, a supercharged air duct having an internal combustion engine; and

FIG. 2: in a schematic top plan view, a motor vehicle having an internal combustion engine.

### DETAILED DESCRIPTION OF THE INVENTION

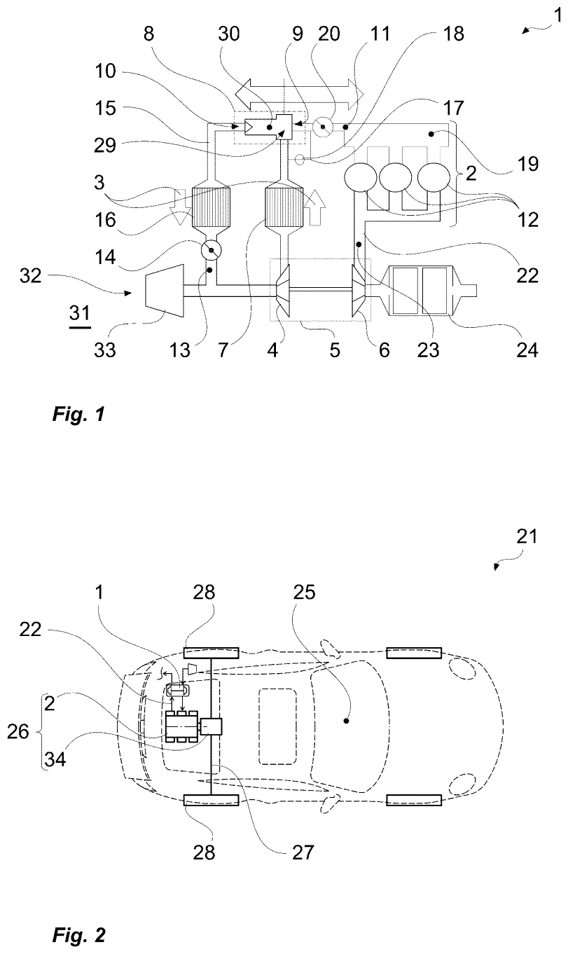

In FIG. 1, in a schematic illustration, a supercharged air duct 1 having an internal combustion engine 2 is shown. The supercharged air duct 1 receives a flow in the indicated flow direction 3. The supercharged air duct 1 starts with a compressor turbine 4 of a turbocharger 5, which is driven by means of an exhaust turbine 6. The supercharged air duct 1 further comprises an intercooler 7 positioned downstream of the compressor turbine 4. A Ranque-Hilsch cyclone tube 8 is arranged after the intercooler 7 and comprises a compressed air inlet 29, a cyclone chamber 30, an inflow outlet 9, and a return flow outlet 10. The inflow outlet 9 is connected to a combustion chamber 12 of an internal combustion engine 2 via an intake chamber 19. The return flow outlet 10 is connected to a return channel 15, which is (purely optionally) equipped with a heat exchanger 16. A bypass channel 17 having a bypass throttle valve 18 is purely optionally also provided in the supercharged air duct 1, via which supercharged air can be conducted behind the intercooler 7 past the Ranque-Hilsch cyclone tube 8 into the intake chamber 19 of the internal combustion engine 2. An inflow throttle valve 20 is configured so as to control the flow volume of supercharged air into the intake chamber 19. The supercharged air compressed by the compressor turbine 4 and pre-cooled by the intercooler 7 is input via the compressed air inlet 29 into the Ranque-Hilsch cyclone tube 8, subdivided there into two flows, whereby an inflow 11 is cooled off and a return flow 13 is heated. At the same time, the two flows are destressed. For example, a ratio of 1:3 (return flow 13 to inflow 11) is set. This can be adjusted via the return throttle 14. Here (purely optionally), the return flow 13 is cooled down to ambient temperature via the heat exchanger 16 and the fresh air is mixed in, which is drawn in via a (usually mandatory) air filter 33 from the environment 31 via the air inlet 32. For an explanation of adjustable temperatures and pressures, reference is made to the foregoing description.

The compressor turbine 4 is connected to a (for example torque-proof) exhaust turbine 6, wherein the exhaust turbine 6 is driven by exhaust gas 23 from the exhaust channel 22 of the internal combustion engine 2, i.e., depending on an operating condition of the internal combustion engine 2. Here, the exhaust gas 23 is directed to an exhaust cleaning device 24 after the exhaust turbine 6 has received a flow. The supercharged air input into the intake chamber 19 is brought to a desired pressure (for example, 2.5 bar) and a desired temperature (for example, 15° C.), whereby the exhaust temperature is also affected, i.e., does not become too high, because the temperature in the combustion chamber 12 does not become too high during combustion. Excess drive energy on the exhaust turbine 6 is not just dissipated here, but rather is used in order to cool the supercharged air, wherein the excessive supercharged air necessarily generated on the compressor turbine 4 in this case, along with an excessive temperature, does not need to be discharged from the intercooler 7 overall, but rather is also converted in the Ranque-Hilsch cyclone tube 8.

In FIG. 2, a schematic top plan view of a motor vehicle 21 having an internal combustion engine 2 is shown as a traction machine on the rear axle. The motor vehicle 21 further comprises a transport cabin 25 configured so as to transport passengers and/or goods. By means of a powertrain 26 of a forward drive axle 27 having (here two) forward drive wheels 28, a forward drive of the motor vehicle 21 can be generated. The powertrain 26 here comprises an internal combustion engine 2, which is connected via a transmission, as well as a differential 34, to the drive wheels 28 in a torque-transmitting manner. The internal combustion engine 2 is equipped with a supercharged air duct 1 (as explained, for example, in FIG. 1), which is indicated herein purely schematically. Furthermore, an exhaust channel 22 is indicated, via which the exhaust gas 23 is discharged from the combustion chambers 12 of the internal combustion engine 2 via an exhaust turbine 6 of the turbocharger 5 of the supercharged air duct 1.

With the supercharged air duct proposed herein, an efficient full-load operation of an internal combustion engine can be achieved by simple means.

The features of the claims can be combined in any technically meaningful manner, for which purpose it is also possible to consult the explanations from the following description and features from the figures, which comprise additional configurations of the invention.

### LIST OF REFERENCE NUMERALS

| | |
|---|---|
| 1 | Supercharged air duct |
| 2 | Internal combustion engine |
| 3 | Flow direction |
| 4 | Compressor turbine |
| 5 | Turbocharger |
| 6 | Exhaust turbine |
| 7 | Intercooler |
| 8 | Ranque-Hilsch cyclone tube |
| 9 | Inflow outlet |
| 10 | Return flow outlet |
| 11 | Inflow |
| 12 | Combustion chamber |
| 13 | Return flow |
| 14 | Return throttle |
| 15 | Return channel |
| 16 | Heat exchanger |
| 17 | Bypass channel |
| 18 | Bypass throttle valve |
| 19 | Intake chamber |
| 20 | Inflow throttle valve |
| 21 | Motor vehicle |
| 22 | Exhaust channel |
| 23 | Exhaust |
| 24 | Exhaust cleaning device |
| 25 | Transport cabin |
| 26 | Powertrain |
| 27 | Forward drive axle |
| 28 | Forward drive wheel |
| 29 | Compressed air inlet |
| 30 | Cyclone chamber |
| 31 | Environment |
| 32 | Air inlet |
| 33 | Air filter |
| 34 | Differential |

What is claimed is:

1. A supercharged air duct for providing supercharged air to an internal combustion engine, said supercharged air duct comprising:
a compressor turbine of a turbocharger;
an intercooler for cooling compressed supercharged air produced by the compressor turbine;
a Ranque-Hilsch cyclone tube having an inflow outlet and a return flow outlet, wherein, during operation, an inflow further cooled from the cooled supercharged air flows out via the inflow outlet towards a combustion chamber of the internal combustion engine and a return flow flows out via the return flow outlet; and
a return throttle for the heated return flow of the Ranque-Hilsch cyclone tube.

2. The supercharged air duct according to claim 1, further comprising a return channel having a heat exchanger disposed between the return flow outlet of the Ranque-Hilsch cyclone tube and the compressor turbine for recirculating the return flow.

3. The supercharged air duct according to claim 1, further comprising a bypass channel having a bypass throttle valve, wherein the bypass channel is configured to conduct supercharged air emanating from the intercooler into an intake chamber of the internal combustion engine while bypassing the Ranque-Hilsch cyclone tube.

4. An internal combustion engine for a motor vehicle comprising:
the supercharged air duct of claim 1;
an intake chamber for the at least one combustion chamber of the internal combustion engine which intake chamber is configured to be charged using the supercharged air duct;
an exhaust channel for discharging exhaust from the at least one combustion chamber via an exhaust turbine of the turbocharger; and
an exhaust cleaning device positioned downstream of the exhaust turbine.

5. A motor vehicle comprising:
a transport cabin,
a powertrain including the internal combustion engine according to claim 4; and
a forward drive axle having at least one forward drive wheel,
wherein the at least one forward drive wheel is configured to be driven in order to propel the motor vehicle using a torque emitted from the powertrain.

6. A method for cooling supercharged air for an internal combustion engine using a supercharged air duct, the supercharged air duct comprising a compressor turbine of a turbocharger; an intercooler for cooling compressed supercharged air of the compressor turbine; a Ranque-Hilsch cyclone tube having an inflow outlet and a return flow outlet, wherein, during operation, an inflow further cooled from the cooled supercharged air flows out via the inflow outlet towards a combustion chamber of the internal combustion engine and a return flow flows out via the return flow outlet; and a return throttle for the heated return flow of the Ranque-Hilsch cyclone tube, wherein the method comprises at least the following steps in the following order:
a. compressing the supercharged air to over 3 bar using the compressor turbine;
b. pre-cooling the compressed supercharged air to between 80° C. and 30° C. using the intercooler; and
c. using the Ranque-Hilsch cyclone tube to cool the pre-cooled supercharged air to a target temperature of below 20° C. and relieving to a target charge pressure of 3 bar or less,
wherein the cooling of the supercharged air to a desired target temperature is controlled by adjusting the return flow from the Ranque-Hilsch cyclone tube of the return throttle,
wherein a flow volume of the return flow is less than a flow volume of an inflow.

7. The method according to claim 6, further comprising
distributing the return flow again via a return channel from the return flow outlet of the Ranque-Hilsch cyclone tube prior to the compressor turbine, and
cooling down the return flow to below 55° C. using the heat exchanger.

8. The method according to claim 6, further comprising controlling the flow volume of the inflow to the internal combustion engine using an inflow throttle valve.

9. The method according to claim 6, wherein the method is started depending on at least one of the following conditions:
ambient temperature;
temperature of the supercharged air in an intake chamber of the internal combustion engine;
rotational speed of an exhaust turbine; and
position of an accelerometer.

10. The method according to claim 6, further comprising bypassing the Ranque-Hilsch cyclone tube by directing supercharged air into a bypass channel that fluidly connects an outlet of the intercooler with an intake chamber of the internal combustion engine,
wherein step c. comprises generating a positive pressure in the intake chamber prior to or upon a change from a bypass operation to a cyclone cooling operation using the Ranque-Hilsch cyclone tube.
